(19) United States
(12) Patent Application Publication
(10) Pub. No.: US 2017/0238213 A1
(43) Pub. Date: Aug. 17, 2017

(54) TCP CONNECTION ESTABLISHMENT AND HANDOVER

(71) Applicant: NOKIA SOLUTIONS AND NETWORKS OY, Espoo (FI)

(72) Inventors: Kumar Praveen BEZAWADA, Chengdu (CN); Yu GAO, Chengdu, Sichuan (CN); Qin Jun ZHU, Chengdu, Sichuan Province (CN)

(21) Appl. No.: 15/502,543

(22) PCT Filed: Sep. 25, 2014
(86) PCT No.: PCT/CN2014/087458

§ 371 Date: Feb. 8, 2017

(51) Int. Cl. H04W 36/00; H04L 29/12; H04W 76/02; H04L 29/06

(52) U.S. Cl. CPC H04W 36/0005; H04L 69/16; H04L 61/6063; H04W 76/022

(57) ABSTRACT

A mechanism for an apparatus in a communication network is described. The mechanism comprises receiving, from a second apparatus (A31), a message comprising an IP address of the second apparatus (A31) and an IP address of a user equipment (A11), wherein said user equipment (A11) being connected to said communication network via the second apparatus (A31); determining if a mapping table relating to the IP address of the user equipment (A11) exists or not; retrieving an IP address from the mapping table based on the IP address of the user equipment (A11) in the event the mapping table exists, wherein said IP address being associated with the IP address of the user equipment (A11) in the mapping table; if the IP address of the second apparatus (A31) is different from the retrieved IP address, sending a request to a third network element (A121) identified by the retrieved IP address to obtain TCP connection details and updating the mapping table by associating the IP address of the user equipment (A11) with the IP address of the second apparatus (A31).

### FIELD OF THE INVENTION

The present invention relates to connection establishment and handover. Specifically, the present invention relates to methods, apparatuses, system and computer program product for connection establishment and handover in a communication network.

### BACKGROUND OF THE INVENTION

While communication business is getting mature and traditional primary revenue sources (e.g. voice & messaging) continue to decline, new opportunities for mobile operators to generate revenue emerge. It is crucial for mobile operators to stake out new territory by offering compelling services that treat subscribers to a truly gratifying and personalized mobile broadband experience. Moving content in close proximity to the mobile subscriber is one example. It provides a more responsive experience to subscribers as content can be delivered quicker and with lower latency.

As one example, Nokia Networks™ recently launched “Liquid Applications”, which provides a new Radio Application Cloud Server (RACS) integrated with base station. With Liquid Applications, data services can be provided directly from base stations, enabling the carrier to deliver media-rich services and content directly from the base station. The service works by enabling data to pass through the base stations. Not only does this means large sets of data avoid having to go through the core network, which increases traffic and in turn latency, they can bounce back to local users and give a more helpful service.

The cloud server (RACS) changes base stations into local hubs for service creation and delivery. Unlike traditional base stations that essentially only played the role of a communication pipe, service-aware RAN (Radio Access Network) is an intelligent base station that provides customers with a unique mobile experience through a wide variety of customized services. Based on the diverse features of intelligent base stations such as localized processing, storage and access to real-time radio and network data, an operator expects to develop services and applications that deliver a contextualized and personalized experience to customers. Unique in the sense that it takes data from inside the base station to create a personalized and contextualized mobile broadband experience. And unique in that it enables the creation of innovative new services that can use proximity and location to connect subscribers and local points of interest, businesses and events.

Just like in a conventional mobile network, a subscriber may roam from one place to another. Handover should be seamless in order to guarantee satisfactory user experience. As one example, when an UE may move from one place to another, connections between the UE and corresponding network elements shall be maintained and handover needs to be handled seamlessly.

### SUMMARY OF THE INVENTION

The present invention and its embodiments seek to address one or more of the above-described issues.

According to one exemplary example of the invention, there is provided a method for a first apparatus in a communication network. The method comprises receiving, from a second apparatus, a message comprising an IP address of the second apparatus and an IP address of a user equipment, wherein said user equipment being connected to said communication network via the second apparatus; determining if a mapping table relating to the IP address of the user equipment exists or not; retrieving an IP address from the mapping table based on the IP address of the user equipment in the event the mapping table exists, wherein said IP address being associated with the IP address of the user equipment in the mapping table; sending a request to a third network element identified by the retrieved IP address to obtain TCP connection details and updating the mapping table by associating the IP address of the user equipment with the IP address of the second apparatus if the IP address of the second apparatus is different from the retrieved IP address.

According to further development of the invention, the method for the first apparatus further comprises receiving the requested TCP connection details from the third apparatus and forwarding the TCP connection details to the second apparatus.

According to further modification of the invention, the method for the first apparatus further comprises saving an association between the IP address of the user equipment and the IP address of the second apparatus as a part of the mapping table in the event that the mapping table does not exist.

According to another aspect of the invention, there is provided a method for a second apparatus in a communication network. The method comprises receiving a request from a user equipment, wherein said request comprising a destination IP address and an IP address of the user equipment; sending a message comprising an IP address of the user equipment and an IP address of the second apparatus to a third apparatus; receiving TCP connection details from the third apparatus; establishing a TCP connection towards the user equipment based on the received TCP connection details; and forwarding the request to a content server identified by the destination IP address.

According to further development of the invention, the method for the second apparatus further comprises receiving a response to the request from the content server and forwarding the response to the user equipment.

According to a third aspect of the invention, there is provided an apparatus comprising a transceiver configured to communicate with at least another apparatus, a memory configured to store computer program code, and a processor. The processor is configured to cause the apparatus to perform: receiving, from a second apparatus, a message comprising an IP address of the second apparatus and an IP address of a user equipment, wherein said user equipment being connected to a communication network via the second apparatus; determining if a mapping table relating to the IP address of the user equipment exists or not; retrieving an IP address from the mapping table based on the IP address of the user equipment in the event the mapping table exists, wherein said IP address being associated with the IP address of the user equipment in the mapping table; sending a request to a third apparatus identified by the retrieved IP address to obtain TCP connection details and updating the mapping table by associating the IP address of the user equipment with the IP address of the second apparatus, if the IP address of the second apparatus is different from the retrieved IP address.

According to further development of the invention, the processor is further configured to cause the apparatus to receive the requested TCP connection details from the third apparatus and forward the TCP connection details to the second apparatus. In a variant, the processor is configured to save an association between the IP address of the user equipment and the IP address of the second apparatus as a part of the mapping table in the event that the mapping table does not exist.

According to a fourth aspect of the invention, there is provided a second apparatus. The second apparatus comprises a transceiver configured to communicate with at least another apparatus, a memory configured to store computer program code, and a processor configured to cause the apparatus to perform: receiving a request from a user equipment, wherein said request comprising a destination IP address and an IP address of the user equipment; sending a message comprising an IP address of the user equipment and an IP address of the second apparatus to a third apparatus; receiving TCP connection details from the third apparatus; establishing a TCP connection towards the user equipment based on the received TCP connection details; and forwarding the request to a content server identified by the destination IP address.

In a variant, the processor of second apparatus is configured to receive a response to the request from the content server and forward the response to the user equipment.

According to a fifth aspect of the invention, there is provided a computer program product comprising computer-executable computer program code which, when the computer program code is executed on a computer, is configured to cause the computer to carry out the methods and their variations as described above. In a variant, the computer program product comprises a computer-readable medium on which the computer-executable computer program code is stored, and/or wherein the program is directly loadable into an internal memory of the processor.

According to a sixth aspect of the invention, there is provided a third apparatus. The third apparatus comprises a transceiving means for communicating with at least another apparatus, a memory for storing computer program code, and a processing means for causing the third apparatus to perform: receiving, from a second apparatus, a message comprising an IP address of the second apparatus and an IP address of a user equipment, wherein said user equipment being connected to a communication network via the second apparatus; determining if a mapping table relating to the IP address of the user equipment exists or not; retrieving an IP address from the mapping table based on the IP address of the user equipment in the event the mapping table exists, wherein said IP address being associated with the IP address of the user equipment in the mapping table; if the IP address of the second apparatus is different from the retrieved IP address, sending a request to an apparatus identified by the retrieved IP address to obtain TCP connection details and updating the mapping table by associating the IP address of the user equipment with the IP address of the second apparatus.

According to a seventh aspect of the invention, there is provided a fourth apparatus comprising a transceiving means for communicating with at least another apparatus, a memory for storing computer program code, and a processing means for causing the fourth apparatus to perform: receiving a request from a user equipment, wherein said request comprising a destination IP address and an IP address of the user equipment; sending a message comprising an IP address of the user equipment and an IP address of the fourth apparatus to a third apparatus; receiving TCP connection details from the third apparatus; establishing a TCP connection towards the user equipment based on the received TCP connection details; and forwarding the request to a content server identified by the destination IP address.

### BRIEF DESCRIPTION OF THE DRAWINGS

Exemplary embodiments of the invention are described below, by way of example only, with reference to the following numbered drawings.

FIG. 1 gives an exemplary overview of network architecture according to one aspect of invention.

FIG. 2 shows signalling flow according to another aspect of the invention.

FIG. 3 shows signalling flow according to one embodiment of the invention.

FIG. 4 illustrates a method according to certain embodiment of the invention.

FIG. 5 illustrates another method according to certain embodiment of the invention.

FIG. 6 depicts a schematic block diagram illustrating two apparatuses according to certain embodiment of the invention.

### DESCRIPTION OF THE EMBODIMENTS OF THE INVENTION

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

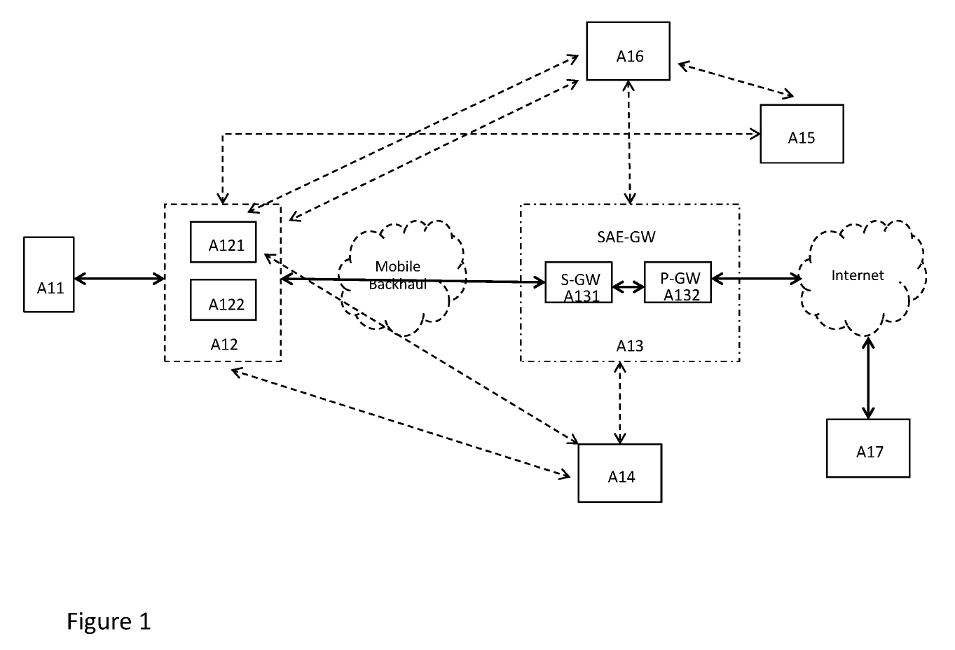

In FIG. 1, a user equipment (UE) A11 may connect to a network via a network element A12, which may be a base station, such as an eNB (e-Node B). The network element A12 may comprise an entity A122, which may be a server such as a cloud server RACS and another entity A121, which may be called FCO-R (Flexi Content Optimizer-R). RACS is a platform on which virtual machine may run. For example, an operator may run its own application on it. Both entities A121 and A122 maybe an independent element attached to the base station A12 or integrated with the base station A12. The FCO-R A121 may have cache storage and may interpret HTTP (Hypertext Transfer Protocol) cache control directives as defined in RFC2616 for caching and retrieving content from cache. A TCP (Transmission Control Protocol) connection via a port 80/8080 from the UE A11 may be terminated in FCO-R A121 and, for traffic on these ports, FCO-R A121 may do L7 HTTP header analysis for any request or response in order to check cache control headers and handle them accordingly—e.g. either cache the response content or, if content exists in cache storage, retrieve the content and send it directly when responding to a request from a UE.

In parallel, the FCO-R A121 may inform a network entity A15, which may be called FCO (Flexi Content Optimizer), the IP (Internet Protocol) address of the UE A11 which is connected to the network via the network entity A121. Such IP address may also be called a source IP address. A list of the source IP address and the IP address of an associated network entity (i.e. the network entity, e.g. A121, through which the UE A11 is connected to the network) may be maintained in the network element A15, which may be called a mapping table.

The network architecture depicted in FIG. 1 may also comprise a core network comprising a network element which may be called SAE-GW (System Architecture Evolution-Gateway) A13. SAE-GW A13 may comprise a network element A131, which may be called S-GW and another network element A132, which may be called P-GW. SAE-GW A13 may be connected to PCS (Policy Control Server) A14 which may provide subscription policy for subscriber. Within the network architecture, there may be a network management entity which may be called NetAct A16. FCO A15 may be part of a core network.

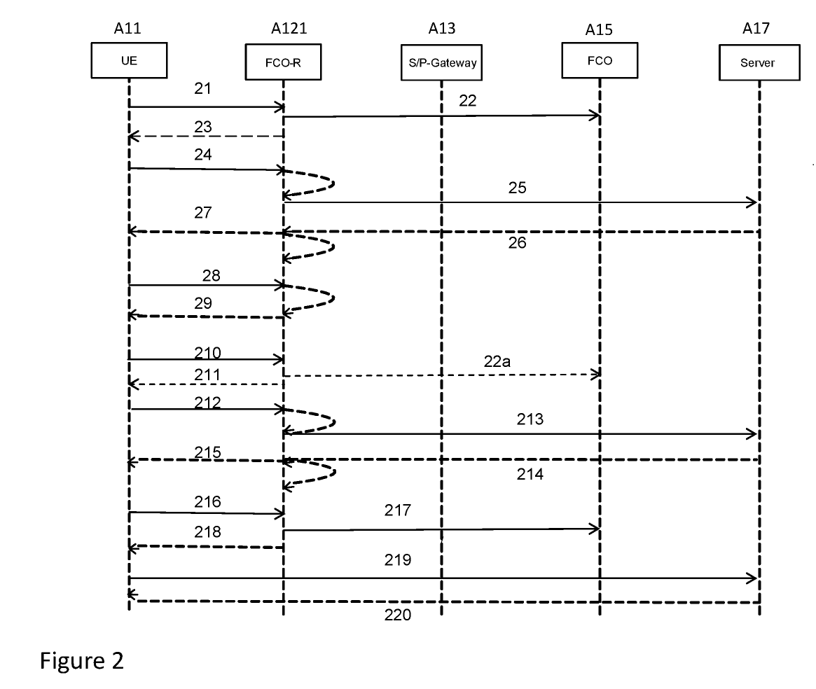

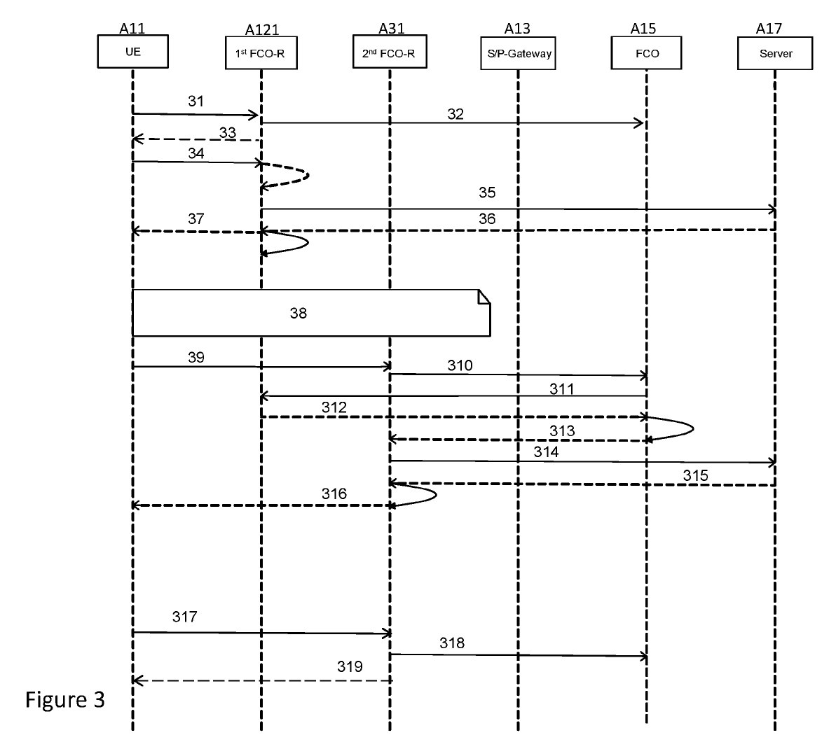

FIG. 2 provides further description of another aspect of the invention. A UE A11 may send a message comprising an IP address of the UE A11 and a destination IP address, e.g. the IP address of a content server A17, to a first FCO-R A121 as shown in step 21. The message may be, for example, a TCP SYN packet. Upon receipt of the message, the FCO-R A121 may send a message comprising a source IP address (i.e. the IP address of the UE) and its own IP address to the FCO A15 as depicted in step 22. The FCO-R A121 may also acknowledge the receipt of the message (i.e. the SYN packet) in step 23. A mapping table between the source IP address and the IP address of FCO-R may be established in FCO A15 if such mapping table has not existed before. The FCO A15 may use the received source IP address as a key to retrieve its associated IP address. If no associated IP address can be found, the FCO A15 may save such association as a part of the mapping table. If the retrieved IP address is identical to the IP address contained in the message, the FCO A15 need not do anything as it refers to a situation where the UE A11 may initiate another TCP connection in addition to an existing one. If, however, the retrieved IP address is different from the IP address contained in the message, it is a handover situation which will be explained in FIG. 3.

After receiving the acknowledgement (ACK) 23 from the first FCO-R A121, the UE A11 may send a HTTP request 24 to the FCO-R A121. For HTTP traffic (i.e. messages sent via port 80 and 8080), FCO-R A121 may perform L7 HTTP header analysis to check if the requested content is already available in the local cache. If not, FCO-R A121 may initiate a TCP connection to a content server (such as the server A17) identified by the received destination IP address and forward the request to the server A17 as shown in step 25.

The TCP connection from the FCO-R A121 to the server A17 and the TCP connection between the UE A11 and FCO-R A121 may be created and closed asynchronously. In other words, the TCP connections indicated by 24 and 25 are independent from each other.

The server A17 may provide the requested content in a response message 26 to the FCO-R A121 which may then forward the content to the UE A11 in step 27 and, at the same time, analyze the cache directives in HTTP response header to check if the content needs to be cached or not. For subsequent requests for the cached content, the FCO-R A121 may serve the content from local cache.

According to one embodiment of the invention, the mapping table may be also saved in the FCO-R A121 locally. When the UE A11 tries to initiate another TCP connection in parallel with the previously established TCP connection, it may send a message (e.g. TCP SYN) 210 comprising a destination IP address to the FCO-R A121. As the mapping table is available locally, which indicates that the same mapping table also exists in the FCO A15 and there is already a TCP connection between the UE A11 and the FCO-R A121, the FCO-R A121 need not send a similar message as in step 22 to the FCO A15. Instead, it may simply acknowledge the receipt of the message in step 211. The UE A11 may then send a HTTP request to the FCO-R A121 in step 212. The rest steps 213 to 215 are identical to the steps 25 to 27.

Alternatively, instead of maintaining a mapping table in the FCO-R A121 locally, it may also send a message to the FCO A15 as indicated by the dotted line 22a, which is a similar message as described in step 22.

When UE terminates the TCP Connection (shown in step 216), FCO-R A121 may close the TCP connection, inform FCO to remove the source IP address and FCO-R IP address mapping and also remove the mapping table locally (in step 217).

For non-HTTP traffic (i.e. traffic not via port 80/8080), the TCP termination may be terminated in the server A17. The TCP SYN packet is forwarded to the core network as usual without any further processing in FCO-R A121 as shown in step 219 and 220.

FIG. 3 describes a handover situation according to another embodiment of the invention. The UE A11 is within the coverage area of a base station comprising a first FCO-R A121 and it may initiate a TCP connection to the server A17. Similar to what have been described in FIG. 2, the TCP SYN packet is intercepted by the first FCO-R A121 and it may send a message comprising the IP address (i.e. source IP address) of the UE A11 and the IP address of the first FCO-R A121.

The steps 31-37 in FIG. 3 are similar to the steps 21-27 in FIG. 2.

Then, the UE A11 may later move to an area covered by a different base station comprising a second FCO-R A31 as shown in step 38. The UE A11 may assume that the TCP connection established with the first FCO-R A121 still exists after moving to a different coverage area. A typical scenario as such is when the UE A11 moves from one place to another during a downloading session. The UE A11 may send a HTTP request (e.g. TCP data packet or TCP ACK packet) comprising the destination IP address to the second FCO-R A31 as shown in 39. The second FCO-R A31 may send a message comprising the source IP address (i.e. the IP address of the UE that sends the HTTP request to the second FCO-R A31) and its own IP address as indicated in step 310. On receipt of the message, the FCO A15 may retrieve the mapping table by using the source IP address as a key. If the IP address associated with the source IP address in the mapping table is different from the IP address of the second FCO-R A31 contained in the message, it is an indication that the UE may not be connected to the network element identified by the IP address associated with the source IP address in the mapping table. As one example of such situation, the UE A11 may roam to a different coverage area.

In step 311, the FCO A15 may send a request to the network element identified by the retrieved IP address from the mapping table in order to obtain connection details of the TCP connection which was previously initiated by the UE A11.

On receipt of the TCP connection details as depicted in step 312, The FCO A15 may forward them to the second FCO-R A31 in step 313. The FCO A15 may also update the mapping table by replacing the IP address of the first FCO-R A121 with the IP address of the second FCO-R A31.

Then the second FCO-R A31 may use the received TCP connection details to handle the HTTP request from the UE as indicated in step 314 316. A11 further TCP data handling over existing connection is handled by the second FCO-R A31 as depicted in 317-319.

The TCP connection details may comprise parameters such as UE local port, initial sequence number, IP address of client/server. In addition, the TCP connection details may also comprise “Sent Bytes” and “Acknowledged Bytes”. “Sent Bytes” indicates how many bytes a FCO-R has already sent to a UE in a downloading session. “Acknowledged Bytes” tells how many bytes a UE has already acknowledged to a FCO-R in a downloading session. “Sent Bytes” may not be equal to “Acknowledged Bytes” in a roaming situation as some bits may still be “in the air” when the UE switches connection from one base station to another. After receiving those bytes “in the air”, the UE may acknowledge to the FCO-R being currently connected so that these bytes need not to be retransmitted. However, the FCO-R needs to retransmit those bits if they are lost.

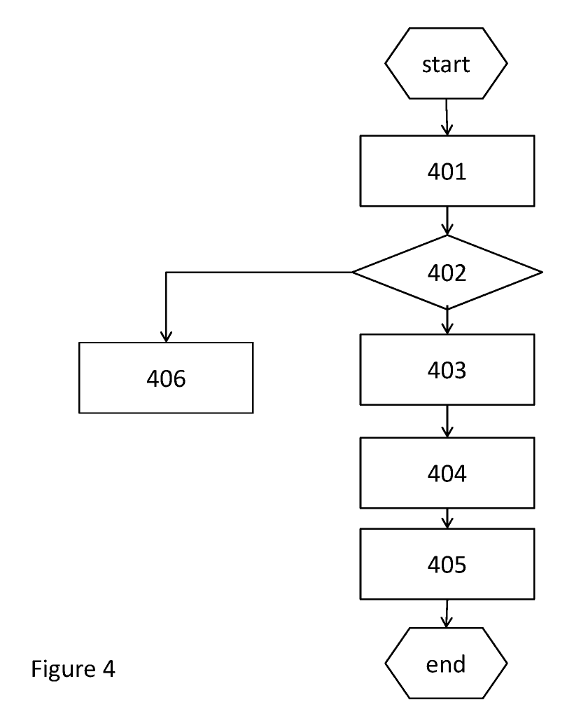

FIG. 4 illustrates a method according to certain embodiment. The method may comprise, at 401, receiving a message comprising a source IP address and an IP address of a network element sending the message, for example, a FCO-R (A121, A31). The method may be performed by a network element such as a FCO (A15). The method may also comprise, at 402, associating the source IP address with the IP address of the FCO-R (A121, A13) which sends the message. Such association may be saved in the FCO (A15) as a part of a mapping table if no mapping table relating to the source IP address exists. If, however, by using the source IP address as a key, it is possible to retrieve an IP address associated with the source IP address from the mapping table, the retrieved IP address may be compared with the IP address contained in the received message. If they are identical, nothing needs to be done in step 406. It may be correspond to a situation where a UE initiates a second TCP connection towards a content provider in addition to the existing TCP connection.

Otherwise, if the retrieved IP address is not the same as the IP address contained in the received message, the method may further comprise, at 403, sending a request to the network element, e.g. a first FCO-R A121, identified by the retrieved IP address in order to request TCP connection details. Upon receiving the requested TCP connection details, as shown in 404, the FCO may update the mapping table by replacing the IP address of the first FCO-R A121 with the IP address contained in the message, e.g. the IP address of the second FCO-R A31. Finally, at 405, the received TCP connection details may be forwarded to the network element which sends the initial message, for instance, the second FCO-R A31.

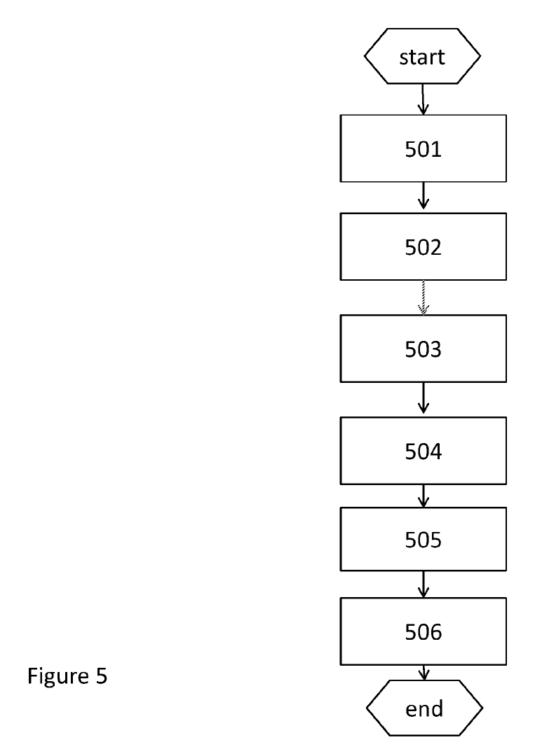

FIG. 5 illustrates another method according to certain embodiment. The method may comprise, at 501, receiving a request, such as a HTTP request, from a UE A11. The request may comprise a destination IP address and an IP address of the UE A11. The method may be performed by a FCO-R, for example, FCO-R A31 or any suitable network element in a communication network. The method may further comprise, at 502, sending a message comprising the IP address of the UE A11 and the IP address of the sender, in this exemplary example, it may be FCO-R A31, to a network element, e.g. FCO A15.

The method may also comprise receiving TCP connection details and establishing a TCP connection towards the UE A11 at 503. The method may further comprise forwarding the received request to a server identified by the destination IP address, e.g. the content server A17, at 504. The method may comprise receiving a response in relation to the forwarded request from the content server A17 at 505 and also forwarding the received response to the UE A11 at 506.

In the above embodiments, although only TCP is mentioned as one type of connection, it is obvious for a skilled person in the art to understand that the method is not limited to TCP connection. Wherever appropriate, the skilled person would adapt the method to any other kind of connections in a network.

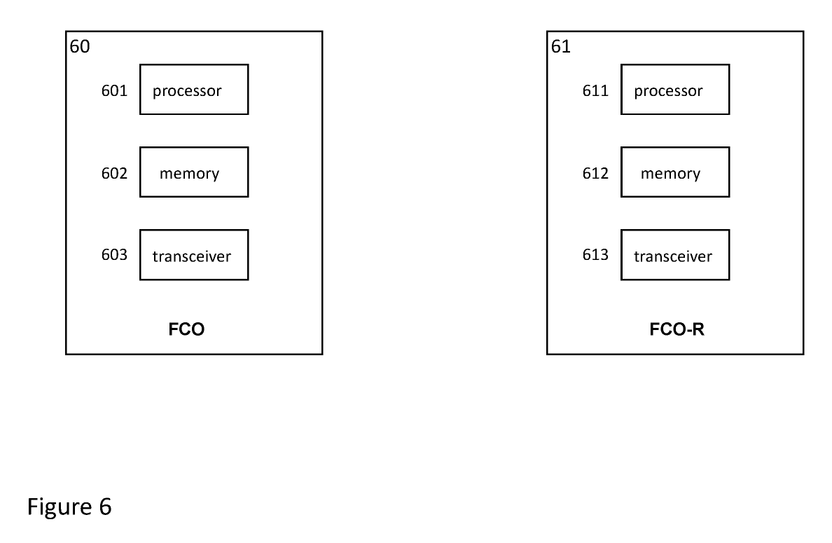

FIG. 6 illustrates two apparatuses according to certain embodiments of the invention. In one embodiment, one apparatus may be a FCO 60 and another apparatus may be a FCO-R 61. Each of these devices may comprise at least one processor (or processing means), respectively indicated as 601 and 611. At least one memory may be provided in each device, and indicated as 602 and 612, respectively. The memory may include computer program instructions or computer code contained therein. The processors 601 and 602 and memories 602 and 612, or a subset thereof, can be configured to provide means corresponding to the various blocks of FIGS. 4 and 5.

As shown in FIG. 6, transceivers (or transceiving means) 603 and 613 may be provided. Transceivers 603 and 613 can each, independently, be a transmitter, a receiver, or both a transmitter and a receiver, or a unit or device that is configured both for transmission and reception. Processors (or processing means) 601 and 611 can be embodied by any computational or data processing device, such as a central processing unit (CPU), application specific integrated circuit (ASIC), or comparable device. The processors can be implemented as a single controller, or a plurality of controllers or processors.

Memories 602 and 612 may independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor (or processing means) for the particular device, to cause a hardware apparatus such as FCO 60 and FCO-R 61, to perform any of the processes described herein (for example, FIGS. 4 and 5). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware. Furthermore, although FIG. 6 illustrates network element such as a FCO and FCO-R, embodiments of the invention may be applicable to other configurations, and configurations involving additional elements. For example, not shown, additional network element may be present, and additional core/radio network elements may be present, as illustrated in FIG. 1.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention. In order to determine the metes and bounds of the invention, therefore, reference should be made to the appended claims.

For the purpose of the present invention as described above, it should be noted that
method steps likely to be implemented as software code portions and being run using a processor at one of the server entities are software code independent and can be specified using any known or future developed programming language;
method steps and/or devices likely to be implemented as hardware components at one of the server entities are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices can be implemented as individual devices, but this does not exclude that they are implemented in a distributed fashion throughout the system, as long as the functionality of the device is preserved.

It is to be understood that the above description is illustrative of the invention and is not to be construed as limiting the invention. Various modifications, applications and/or combination of the embodiments may occur to those skilled in the art without departing from the scope of the invention as defined by the appended claims.

1. A method for a first apparatus in a communication network comprising:
receiving, from a second apparatus, a message comprising an IP address of the second apparatus and an IP address of a user equipment, wherein said user equipment being connected to said communication network via the second apparatus;
determining if a mapping table relating to the IP address of the user equipment exists or not;
retrieving an IP address from the mapping table based on the IP address of the user equipment in the event the mapping table exists, wherein said IP address being associated with the IP address of the user equipment in the mapping table;
if the IP address of the second apparatus is different from the retrieved IP address, sending a request to a third network element identified by the retrieved IP address to obtain TCP connection details and updating the mapping table by associating the IP address of the user equipment with the IP address of the second apparatus.

2. The method according to claim 1, further comprising receiving the requested TCP connection details from the third apparatus and forwarding the TCP connection details to the second apparatus.

3. The method according to claim 1 further comprising
saving an association between the IP address of the user equipment and the IP address of the second apparatus as a part of the mapping table in the event that the mapping table does not exist.

4. A method for a first apparatus in a communication network, said method comprising:
receiving a request from a user equipment, wherein said request comprising a destination IP address and an IP address of the user equipment;
sending a message comprising an IP address of the user equipment and an IP address of the first apparatus to a second apparatus;
receiving TCP connection details from the second apparatus;
establishing a TCP connection towards the user equipment based on the received TCP connection details; and
forwarding the request to a content server identified by the destination IP address.

5. The method according to claim 4, further comprising receiving a response to the request from the content server and forwarding the response to the user equipment.

6. A first apparatus, comprising:
a transceiver configured to communicate with at least another apparatus,
a memory configured to store computer program code, and
a processor configured to cause the first apparatus to perform:
receiving, from a second apparatus, a message comprising an IP address of the second apparatus and an IP address of a user equipment, wherein said user equipment being connected to a communication network via the second apparatus;
determining if a mapping table relating to the IP address of the user equipment exists or not;
retrieving an IP address from the mapping table based on the IP address of the user equipment in the event the mapping table exists, wherein said IP address being associated with the IP address of the user equipment in the mapping table;
if the IP address of the second apparatus is different from the retrieved IP address, sending a request to a third apparatus identified by the retrieved IP address to obtain TCP connection details and updating the mapping table by associating the IP address of the user equipment with the IP address of the second apparatus.

7. The first apparatus according to claim 6, wherein the processor is configured to cause the apparatus to receive the requested TCP connection details from the third apparatus and forward the TCP connection details to the second apparatus.

8. The first apparatus according to claim 6, wherein the processor is configured to save an association between the IP address of the user equipment and the IP address of the second apparatus as a part of the mapping table in the event that the mapping table does not exist.

9. A first apparatus, comprising:
a transceiver configured to communicate with at least another apparatus,
a memory configured to store computer program code, and
a processor configured to cause the first apparatus to perform:
receiving a request from a user equipment, wherein said request comprising a destination IP address and an IP address of the user equipment;
sending a message comprising an IP address of the user equipment and an IP address of the first apparatus to a second apparatus;
receiving TCP connection details from the second apparatus;
establishing a TCP connection towards the user equipment based on the received TCP connection details; and
forwarding the request to a content server identified by the destination IP address.

10. The first apparatus according to claim 9, wherein the processor is configured to receive a response to the request from the content server and forward the response to the user equipment.

11. A first apparatus, comprising:
a transceiving means for communicating with at least another apparatus,
a memory for storing computer program code, and
a processing means for causing the third apparatus to perform:
receiving, from a first apparatus, a message comprising an IP address of the first apparatus and an IP address of a user equipment, wherein said user equipment being connected to a communication network via the first apparatus;
determining if a mapping table relating to the IP address of the user equipment exists or not;
retrieving an IP address from the mapping table based on the IP address of the user equipment in the event the mapping table exists, wherein said IP address being associated with the IP address of the user equipment in the mapping table;
if the IP address of the first apparatus is different from the retrieved IP address, sending a request to a second apparatus identified by the retrieved IP address to obtain TCP connection details and updating the mapping table by associating the IP address of the user equipment with the IP address of the first apparatus.

12. A first apparatus comprising
a transceiving means for communicating with at least another apparatus,
a memory for storing computer program code, and
a processing means for causing the fourth apparatus to perform:
receiving a request from a user equipment, wherein said request comprising a destination IP address and an IP address of the user equipment;
sending a message comprising an IP address of the user equipment and an IP address of the first apparatus to a second apparatus;
receiving TCP connection details from the second apparatus;
establishing a TCP connection towards the user equipment based on the received TCP connection details; and
forwarding the request to a content server, identified by the destination IP address.

13. A computer program product embodied on a non-transitory computer-readable medium, said product comprising computer-executable computer program code which, when the computer program code is executed on a computer, is configured to cause the computer to carry out the method according to claim 1.

14. (canceled)
